(19) United States
(12) Patent Application Publication
(10) Pub. No.: US 2006/0268290 A1
(43) Pub. Date: Nov. 30, 2006

(54) Printing table for flatbed printers

(75) Inventors: Christian Willmann, Buchenbach (DE); Markus Hilpert, Gundelfingen (DE)

Correspondence Address: CROWELL & MORING LLP;INTELLECTUAL PROPERTY GROUP, P.O. BOX 14300, WASHINGTON, DC, 20044-4300, US

(73) Assignee: THIEME GmbH & Co. KG, Teningen (DE)

(21) Appl. No.: 11/440,029

(22) Filed: May 25, 2006

Related U.S. Application Data
(60) Provisional application No. 60/685,019, filed on May 27, 2005.

(30) Foreign Application Priority Data
May 25, 2005 (EP) 050 11 312.5

(51) Int. Cl. G06F 15/00

(52) U.S. Cl. 358/1.1

(57) ABSTRACT

A printing table for flatbed printers, for example, for digital flatbed printers, includes a printing table cover plate, a printing table bottom plate, and a printing table intermediate plate, which is disposed between the printing table cover plate and the printing table bottom plate. The printing table intermediate plate is provided with channels for conveying coolant.

FIG. 6 is an enlarged view of a detail VI in FIG. 2;

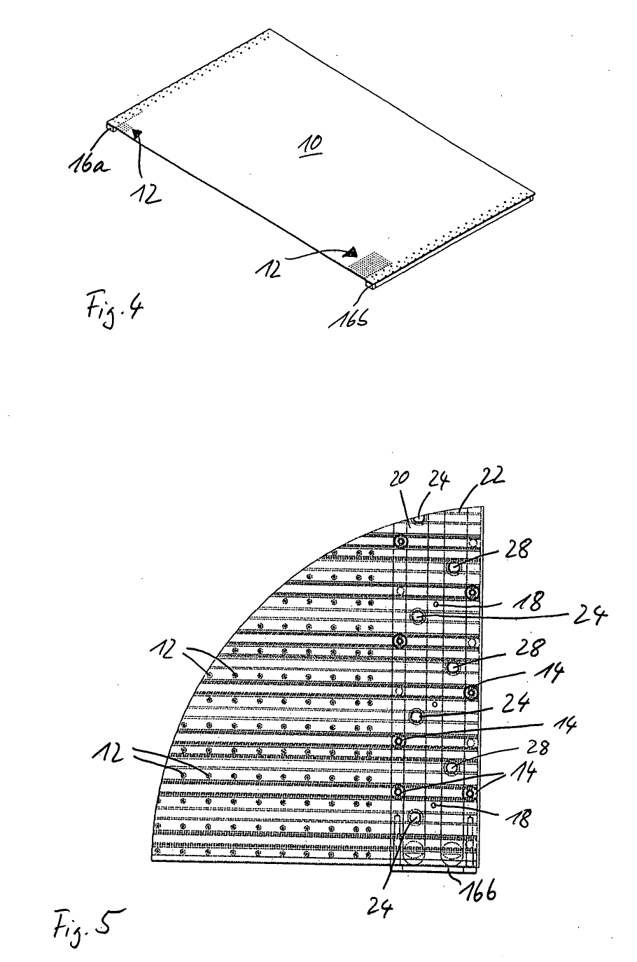

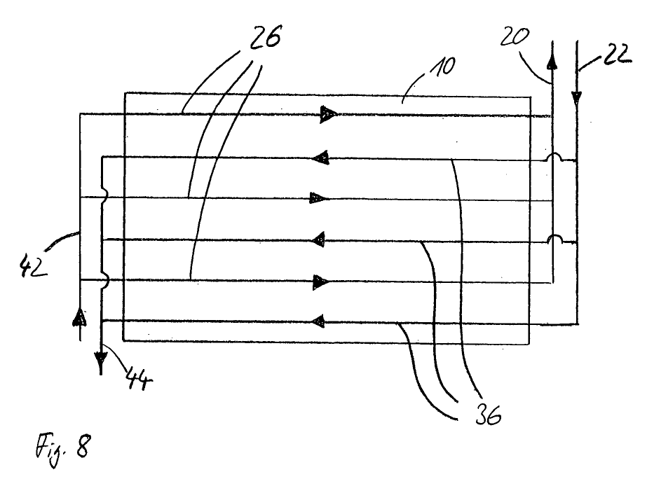

FIG. 7 is an enlarged view of a detail VII in FIG. 3; and

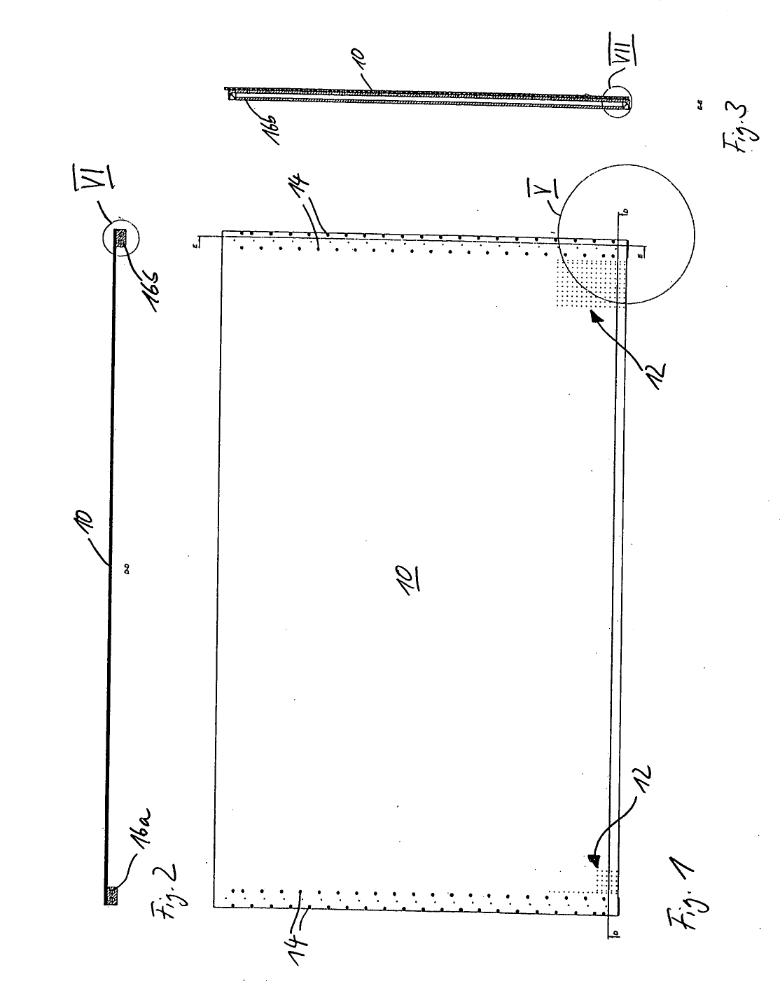

FIG. 8 is a schematic drawing of the flow through the coolant channels in the printing table in FIG. 1.

### DETAILED DESCRIPTION OF THE DRAWINGS

FIG. 1 is a top view of the inventive printing table 10. The printing table 10 exhibits a flat surface, which is penetrated by numerous negative pressure boreholes 12, of which only a subgroup is depicted in FIG. 1. Owing to the negative pressure boreholes 12, which, with the exception of the right and left side areas in FIG. 1, are distributed largely uniformly over the entire surface of the printing table 10, a medium, for example, a sheet of paper, which is to be printed on and which lies on the printing table 10, can be sucked against the printing table surface. In this way it can be guaranteed that the medium to be printed on rests in its entirety on the surface of the printing table. This feature together with a printing table surface that is as flat as possible is very important, especially in the case of digital flatbed printers, because, for example, inkjet print heads must be guided over the medium to be printed on at a constant distance of about one millimeter in order to obtain an accurate printed image.

The right and left side areas of the printing table 10 show several fastening screws 14, which serve to fasten the channel components (to be discussed below) to the printing table 10.

The sectional view in FIG. 2 along the line D-D in FIG. 1 of the printing table 10 shows the channel components 16a, 16b, which are disposed on the right or left edge. Each of these channel components 16a, 16b exhibits two channel boreholes, which serve to feed in or carry away coolant into or away from the printing table 10.

The drawing in FIG. 3 is a sectional view along the line E-E in FIG. 1; and, as can be inferred from FIG. 3, the cutting plane runs through one of the channels in the channel component 16b. In FIG. 3 one can already recognize that of the channels in the channel component 16b, side channels branch off in the direction of the printing table 10 in order to provide the channels in the printing table 10 with coolant.

FIG. 3 also shows that both the front and rear end of the channels of the channel components 16a, 16b are accessible from below the printing table 10 and can be attached to the coolant lines.

The drawing in FIG. 4 is a perspective view of the printing table 10. As in FIG. 1, only a subgroup of the negative pressure boreholes 12 is depicted. The view in FIG. 4 shows the channel components 16a, 16b.

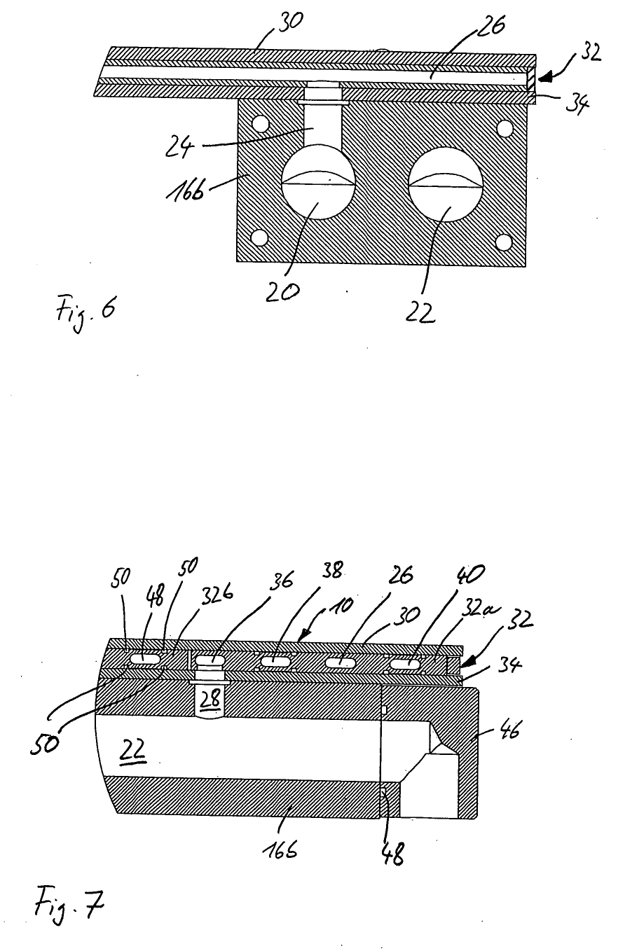

The drawing in FIG. 5 is an enlarged view of a detail V in FIG. 1. In the drawing in FIG. 5, the components that would not be visible per se in the top view of FIG. 5 are represented by dashed lines. As in FIG. 1, the top view in FIG. 5 shows only the negative pressure boreholes 12, which lead into the printing table surface; the boreholes 14, which also lead into the printing table surface and are intended for the fastening screws; as well as other boreholes 18. It also shows the end of the channel component 16b.

In addition, the coolant channels in the printing table 10 as well as the coolant channels and the side channels 24, 28 in the channel component 16b are shown as dashed lines. Furthermore, one can see that end pieces are fastened with screw bolts to the face sides of the channel component 16b and in the same way (not illustrated) also to the channel component 16a. The end pieces effect a 90° bypass of the coolant flow in the downward direction.

The sectional view in FIG. 6 shows a detail VI of FIG. 2. The channel component 16b exhibits a first coolant channel 20, which is provided, for example, for the infeed of coolant. Parallel to the first coolant channel 20, a second coolant channel 22, which is provided, for example, for the purpose of draining the coolant, runs in the channel component 16b. The first coolant channel 20 is connected by way of a side channel 24 to a channel 26 in the printing table intermediate plate 32. The second coolant channel 22 is connected by way of a side channel of the same kind (which cannot be seen in FIG. 6) to a channel, which runs parallel to the channel 26. As one can see in the top view of FIG. 5, side channels 24 are connected to every fourth channel in the printing table intermediate plate 32; and in the same way the side channels 28, issuing from the channel 22, are connected to every fourth channel in the printing table intermediate plate 32. In this way only every second channel is used for conveying coolant.

Thus, coolant, fed through the first coolant channel 20 in the channel component 16b, flows into the channels 26 in the printing table intermediate plate 32, is conveyed through the channels 26 to the opposite channel component 16a, and from there is carried away again by way of one of two coolant channels that run parallel to each other. Starting from the channel component 16a, the coolant, which is fed into the printing table intermediate plate, is conveyed through the printing table by way of the channels, which are different from the channels 26, flows then by way of the side channels 28 into the coolant channel 22 in the channel component 16b and is carried away by the same.

As evident from the sectional view in FIG. 7, which corresponds to the detail VII in FIG. 3, the printing table 10 exhibits a printing table cover plate 30, a printing table intermediate plate 32 and a printing table bottom plate 34. The printing table cover plate 30 is designed as a solid plate, for example, made of aluminum. In the same way the printing table bottom plate 34 is made as a solid plate, for example of aluminum. The printing table intermediate plate 32 comprises several aluminum extruded profiles 32a, 32b, which are arranged side-by-side and which are provided with channels 26, 36, 38, 40, 48, which are arranged parallel to each other. The channel 26, which is supplied with coolant from the coolant channel 20 by way of the side channel 24, could already be clearly seen in FIG. 6. FIG. 7 shows that a side channel 28, which issues from the second coolant channel 22, connects a channel 36 in the extruded profile 32a. In addition, the extruded profile 32a exhibits two other channels 38, 40, which are not supplied with coolant and consequently are not connected to the first or second coolant channel 20, 22. Other side channels 28, which issue from the second coolant channel 22, connect a channel (no longer shown in FIG. 7) to the second coolant channel 22 in the extruded profile 32b, so that, when seen over the entire width of the printing table 10, one channel 36 in each extruded profile 32a, 32b is connected to the second coolant channel 22. In the same way one channel 26 of all extruded profiles 32a, 32b is connected to the first coolant channel 20 by way of the respective side channel 24. An analogous configuration can be found in the area of the coolant channel component 16a.

On the whole, the result is a coolant flow, as shown as a schematic drawing in FIG. 8. The flow direction of the coolant alternates between the adjoining coolant channels 26, 36 in the printing table 10. In this way, it is ensured that neither a hot nor a cold side of the printing table 10 can develop, because a higher temperature on the downstream end of the channels 26 is compensated by a lower temperature on the adjacent, upstream end of the channels 36 and vice versa.

In addition, the schematic drawing in FIG. 8 shows that irrespective of whether the coolant flows through the channels 26 or 36 and irrespective of which channel 26, 36 the coolant flows through, it must always travel the same path, because the channels 26, which exhibit the same flow direction, branch off from an inflow collecting channel 42, which runs perpendicular to the longitudinal direction of the channels 26, and empty in succession in the outflow collecting channel 22, which runs perpendicular to the longitudinal direction of the channels. In an analogous manner the channels 36 branch off in succession from the inflow collecting channel 20 and empty in succession in an outflow collecting channel 44. In this way it can be guaranteed that all channels 26, 36 experience the same flow losses; and, thus, the same amount of coolant flows through all channels 26, 36 in the same period of time.

FIG. 7 shows in turn that the face side of the channel component 16b is provided with an end piece 46, which brings about a 90 deg. deflection of the flow direction of the channels 20, 22. The end piece 46 is connected by way of a screw bolt (which is not shown in FIG. 7) to the channel component 16b and is sealed off from the same by sealing rings (not illustrated) in the sealing grooves 48.

FIG. 7 also shows that the printing table cover plate 30 is glued together with the extruded profile 32a of the printing table intermediate plate 32 by way of strip-shaped adherent surfaces above the channels 38, 40. In the same way the printing table plate 32 is glued together with the printing table bottom plate 34 by way of strip-shaped adherent surfaces below the channels 38, 40. The extruded profile 32b of the printing table intermediate plate 32, of which only segments are depicted in FIG. 7, exhibits the strip-shaped adherent surfaces above and/or below the channel 48.

When seen over the length of the printing table, the strip-shaped adherent surfaces are disposed only above and/or below every second channel 38, 40, 48 and, in addition, are arranged only above and/or below the channels 38, 40, 48, which do not convey any coolant. The result of providing adherent surfaces is, as a rule, a lower transmission of heat, because adhesive is generally a poor heat conductor. However, in the area above the coolant-conveying channels 26, 36 the printing table cover plate 30 rests with its surface on the extruded profiles 32a, 32b; and in an analogous manner the printing table bottom plate 34 rests with its surface on the extruded profiles 32a, 32b below the coolant-conveying channels 26, 36. Thus, it has been ensured that in the area of the coolant-conveying channels 26, 36 there is good heat transmission between the printing table intermediate plate 32 and the printing table cover plate 30 and/or the printing table bottom plate 34.

To guarantee that not too much applied adhesive gets into the area above or below the coolant-conveying channels 26, 36, but rather remains restricted on defined, strip-like adherent surfaces, the strip-shaped adherent surfaces are defined by adhesive grooves 50 in the extruded profiles 32a, 32b. Excess adhesive can enter into the adhesive grooves 50, so that, on the one hand, the adherent surfaces are clearly defined and, on the other hand, excess adhesive cannot result in irregularities on the surface of the printing table 10.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing table for flatbed printers, comprising:
a printing table cover plate;
a printing table bottom plate;
a printing table intermediate plate, which is disposed between the printing table cover plate and the printing table bottom plate; and
wherein the printing table intermediate plate is provided with channels for conveying coolant.

2. The printing table as claimed in claim 1, wherein the printing table intermediate plate includes a plurality of channels, which run parallel to each other and are spaced apart at regular intervals, wherein only a subgroup of the channels are provided for conveying coolant.

3. The printing table as claimed in claim 2, wherein every second channel is provided for conveying coolant.

4. The printing table as claimed in claim 1, wherein the printing table intermediate plate is made of several extruded profiles that are arranged side-by-side.

5. The printing table as claimed in claim 2, wherein the printing table intermediate plate is made of several extruded profiles that are arranged side-by-side.

6. The printing table as claimed in claim 3, wherein the printing table intermediate plate is made of several extruded profiles that are arranged side-by-side.

7. The printing table as claimed in claim 4, wherein the channels are formed inside the extruded profiles.

8. The printing table as claimed in claim 6, wherein the channels are formed inside the extruded profiles.

9. The printing table as claimed in claim 1, wherein the printing table intermediate plate is glued together with at least one of the printing table cover plate and the printing table bottom plate.

10. The printing table as claimed in claim 8, wherein the printing table intermediate plate is glued together with at least one of the printing table cover plate and the printing table bottom plate.

11. The printing table as claimed in claim 10, further comprising:
several strip-like, parallel running adherent surfaces, arranged between the printing table intermediate plate, the printing table cover plate and/or the printing table bottom plate.

12. The printing table as claimed in claim 11, wherein the several strip-like adherent surfaces run above and/or below only a subgroup of the channels.

13. The printing table as claimed in claim 11, wherein the several strip-like adherent surfaces run above and/or below every second channel.

14. The printing table as claimed in claim 12, wherein the several strip-like adherent surfaces run above and/or below every second channel.

15. The printing table as claimed in claim 11, wherein the several strip-like adherent surfaces do not run above and/or below the coolant-conveying channels in the printing table intermediate plate.

16. The printing table as claimed in claim 12, wherein the several strip-like adherent surfaces do not run above and/or below the coolant-conveying channels in the printing table intermediate plate.

17. The printing table as claimed in claim 13, wherein the several strip-like adherent surfaces do not run above and/or below the coolant-conveying channels in the printing table intermediate plate.

18. The printing table as claimed in claim 11, wherein both sides of the strip-like adherent surfaces exhibit grooves for receiving adhesive in at least one of the printing table intermediate plate, the printing table cover plate, and the printing table bottom plate.

19. The printing table as claimed in claim 15, wherein both sides of the strip-like adherent surfaces exhibit grooves for receiving adhesive in at least one of the printing table intermediate plate, the printing table cover plate, and the printing table bottom plate.

20. The printing table as claimed in claim 1, wherein when viewed perpendicular to a longitudinal direction of the channels, a flow direction of each successive coolant conveying channel is in an opposite direction

21. The printing table as claimed in claim 1, wherein the channels, which are provided for coolant and exhibit a same direction of flow, branch off one after the other from an inflow collecting channel, which runs perpendicular to a longitudinal direction of the channels, and empty one after the other in an outflow collecting channel, which runs perpendicular to the longitudinal direction of the channels, so that a flow path from a beginning of the inflow collecting channel as far as to one end of the outflow collecting channel is the same length for all channels, which are provided for the coolant and exhibit the same direction of flow.
